(19) United States
(12) Patent Application Publication
(10) Pub. No.: US 2010/0147206 A1
(43) Pub. Date: Jun. 17, 2010

(54) HURRICANE SUPPRESSION BY SUPERSONIC BOOM

(75) Inventors: A. I. Leonov, Akron, OH (US); A. Gagov, Akron, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/445,104

(22) PCT Filed: Oct. 15, 2007
(86) PCT No.: PCT/US07/21971

§ 371 Date: Feb. 2, 2010

Related U.S. Application Data
(60) Provisional application No. 60/851,616, filed on Oct. 13, 2006.

(51) Int. Cl. B06B 1/00; B06B 1/20; B64C 30/00

(52) U.S. Cl. 116/137 A; 181/142

(57) ABSTRACT

The present invention generally relates to tropical cyclones or hurricanes (typhoons). In one embodiment, the present invention relates to the method of suppressing, mitigating and/or completely eliminating hurricane structures via the destabilizing effect of supersonic booms generated by one or more airplanes capable of supersonic flight (e.g., supersonic-capable fighter planes).

### FIELD OF THE INVENTION

The present invention generally relates to tropical cyclones or hurricanes (typhoons). In one embodiment, the present invention relates to the method of suppressing, mitigating and/or completely eliminating hurricane structures via the destabilizing effect of supersonic booms generated by one or more airplanes capable of supersonic flight (e.g., supersonic-capable fighter planes).

### BACKGROUND OF THE INVENTION

Intense tropical cyclones, called hurricanes in the Atlantic Ocean and eastern Pacific Ocean, and typhoons in the western Pacific and Indian Oceans, destroy whole regions when such storms make landfall. Several hurricanes attack the southern, eastern and/or southwestern coastal regions of the United States during a typical June through November hurricane season. Additionally, a wide range of other geographical areas around the world are also effected by such storms (e.g., India, coastal parts of Africa, Australia and the coastal areas of the Far East).

As would be apparent to a wide range of people, such storms are responsible for a far reaching amount of economic and human destruction including, but not limited to, structural damage of buildings and huge financial losses that can run into the billions of dollars (e.g., 10 billion US dollars or more).

Several books and numerous papers (see, e.g., K. Emmanuel, Divine Winds, Oxford University Press, Oxford, New York (2005)) describe hurricane/typhoon development, growth, movement (or travel characteristics) and death. For example, most hurricanes in north Atlantic (i.e., the portion of the Atlantic Ocean north of the Earth's equator) form and mature in an area near the Earth's equator and travel in a generally north and/or westerly path towards the eastern and southeastern coasts of the United States, or the eastern coast of Mexico and Central America. In rare cases, hurricanes do occur further north in areas nearer to the eastern and/or southeastern seaboards of the United States.

### Hurricane/Typhoon Structure:

A structural sketch of a mature hurricane/typhoon traveling in the open ocean is presented in FIG. 1. It should be noted that the direction of the cyclonic circulation of such weather features depends on the hemisphere in which they are located with those in the northern hemisphere rotating in a counterclockwise direction, while those in the southern hemisphere rotate in a clockwise direction.

FIG. 1 represents, in a simplified manner, a rotating column (“eye”) of air, ascending near an eye wall radius, rₒ, of about 30 to 40 km, which has a maximum tangential (rotational) speed, ca, of 50 to 70 m/sec. The eye is surrounded by huge air masses of radius rₐ of about 500 to 600 km, rotating with decreasing angular speed from a maximum at/near the eye wall to zero, or near zero, at the hurricane/typhoon periphery. The total height of a hurricane is about 20 km. Above an altitude of about 2 to about 3 km, a hurricane/typhoon produces several types of rotating clouds with horizontal dimension slightly less than rₐ. Horizontally, hurricanes and/or typhoons generally travel at a speed of 2 to 7 m/sec.

### Hurricane Functioning:

To a side observer a hurricane/typhoon looks like as a giant machine, whose parts all work in unison to maintain its steady and stable functioning. The most remarkable hurricane/typhoon feature is the rotation of huge air masses in a cyclonic fashion, as is discussed above. This rotation is acquired during the maturation stage of a hurricane/typhoon, and is well maintained by the heat and water vapor released at the ocean surface with the rotational air masses at a hurricane's/typhoon's bottom in spite of some energy losses due to friction and the generation of oceanic waves. This rotation creates a pressure defect in the centerline of hurricane/typhoon, which at its bottom is called tropical depression. The tropical depression at the centerline of a hurricane/typhoon stabilizes the rotating central column of air. Hurricanes/typhoons tend to move mostly along paths where the highest water surface temperatures exist. This horizontal motion along a warm water and/or air produces an ascending vertical airflow of warm and humid air in the eye wall. This upward vertical stream of warm and humid air in the central hurricane eye jet is the third remarkable hurricane feature. At a certain altitude, low atmospheric pressure and a low temperature result in the condensation of vapor in the humid air, causing the formation of spiral bands (protuberances), rotating clouds of different types, and rainfall that surround the eye portion of a hurricane/typhoon. Because of the size and widespread nature of a hurricane/typhoon, the features thereof (e.g., the winds and rainfall) can exist for several days to a week after making landfall. This is because the air mass maintains its rotation even after making land fall.

The above description shows that a functioning hurricane accumulates a huge amount of energy (e.g., approximately 10¹⁵ to 10¹⁶ joules) which is comparable to the energy of one megaton nuclear bomb. Given this, it means that direct “peaceful” destruction of a hurricane/typhoon would require almost the same amount of energy, and is thus, for all practical purposes, impossible. Nevertheless, there are some methods that would permit through the application of relatively low energy, one to destabilize various airflows in a hurricane/typhoon thereby resulting in a strength reduction and/or elimination of a hurricane/typhoon.

### Previous Attempts/Theories for Hurricane/Typhoon Control:

To date a number of methods/theories relating to hurricane/typhoon control, dissipation and/or suppression have been offered. Most have focused on ways to achieve air cooling, considered by their proponents as a main source and/or reason for the continuance of hurricane/typhoon strength. One early attempt slightly reduced a hurricane's intensity by dispersing at high altitude silver iodine particles. This caused an increase in condensation in the seeded portion of the cloud mass of a hurricane and a heat-reducing (or cooling) rainfall. Another mitigation proposal focused on cooling a large area of ocean by pumping cold sea water from well below the surface of the ocean. Also forwarded as a possible hurricane/typhoon control, dissipation and/or suppression methods is the use of various powdered chemicals to achieve a cooling (or exothermic) effect within a hurricane/typhoon. Unfortunately, the most effective endothermic chemicals are detrimental to the environment and expensive. Environmentally friendly chemicals such as potassium chloride (KCl) are cheap and easy to use, but not very effective as the amount needed to actually impact a hurricane/typhoon is on the order of about 40 tons per second of KCl in an area having a radius of about 20 km to about 30 km around a hurricane's/typhoon's eye wall. This amount of powdered KCl is generally necessary in order to achieve 0.8° C. cooling under ideal conditions. Accordingly, it is believed that such methods are unrealistic for one reason or another.

Besides temperature suppression, there are two other aspects of hurricane/typhoon function, rotation and the stabilizing pressure effect, which might be directly targeted in an attempt to control, dissipation and/or suppression have been offered hurricanes/typhoons. To date no attempt to destabilize the rotation and the pressure effect aspects of a hurricanes/typhoons has been made/reported.

### SUMMARY OF THE INVENTION

The present invention generally relates to tropical cyclones or hurricanes (typhoons). In one embodiment, the present invention relates to the method of suppressing, mitigating and/or completely eliminating hurricane structures via the destabilizing effect of supersonic booms generated by one or more airplanes capable of supersonic flight (e.g., supersonic-capable fighter planes).

In one embodiment, the present invention relates to a method of suppressing or completely eliminating the hurricane structures by using supersonic booms generated from supersonic-capable aircraft (e.g., jet fighters). Jet fighters flying at supersonic speeds along special trajectories with a hurricane/typhoon at various altitudes would create supersonic booms. In one such embodiment, the trajectories for the supersonic booms of the present invention are counter to the rotational component of the hurricane and/or typhoon being targeted. As such, supersonic booms can be tailored and/or designed to partially and/or fully negate the basic rotational contribution in a hurricane by slowing down a hurricane's/typhoon's rotation. Additionally, when supersonic booms propagate downward to the surface of the ocean they also destabilize a hurricane's/typhoon's structure by increasing the pressure in the central part of a hurricane's/typhoon's eye.

In one embodiment, the present invention relates to a method of suppressing, mitigating and/or destroying a hurricane/typhoon due to the destabilizing effect of one or more sonic booms. In another embodiment, the sonic booms of the present invention are generated by one or more aircraft capable of supersonic flight speeds.

In still another embodiment, the one or more aircraft generating the one or more sonic booms travel in essentially elliptical flight patterns in a direction that is opposite to the rotation direction of the hurricane's/typhoon's direction of rotation.

In still yet another embodiment, the one or more sonic booms of the present invention are generated, via any suitable means (e.g., suitable aircrafts), in an area in and/or around a hurricane's/typhoon's eye wall.

In still yet another embodiment, additional sonic booms are generated, via any suitable means (e.g., suitable aircrafts), at low altitudes along the hurricane's/typhoon's direction of travel.

### BRIEF DESCRIPTION OF THE DRAWINGS

FIG. 1 is a cross-section drawing of the structure of a typical hurricane/typhoon, with some major air flow patterns detailed therein;

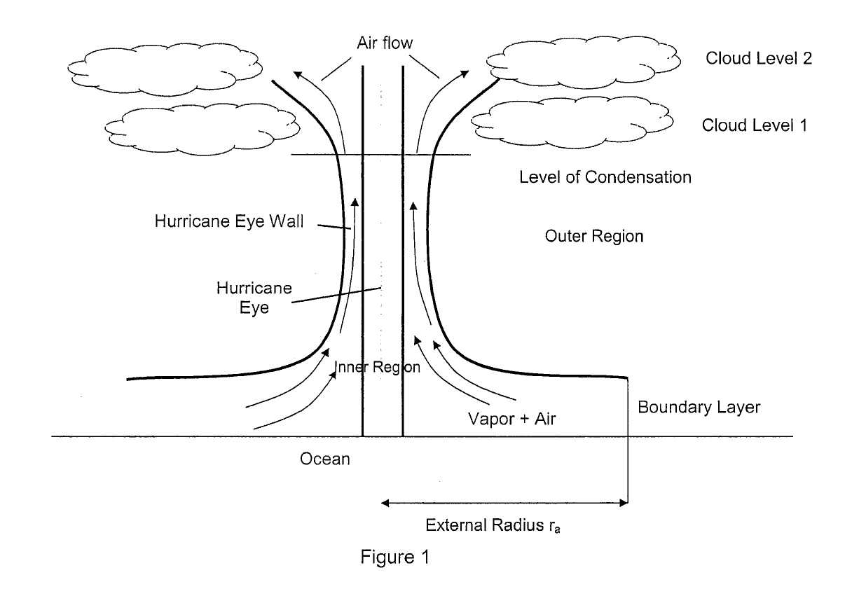

FIG. 2 is an illustration representing one possible flight trajectory for partially and/or fully negate the basic rotational contribution in a hurricane/typhoon located in the northern hemisphere; and

FIG. 3 is a top-down illustration representing one possible near ocean surface flight trajectory within and near the eye wall of a hurricane for partially and/or fully negate the basic rotational contribution in the hurricane/typhoon located in the northern hemisphere.

### DETAILED DESCRIPTION OF THE INVENTION

The present invention generally relates to tropical cyclones or hurricanes (typhoons). In one embodiment, the present invention relates to the method of suppressing, mitigating and/or completely eliminating hurricane structures via the destabilizing effect of supersonic booms generated by one or more airplanes capable of supersonic flight (e.g., supersonic-capable fighter planes).

In one embodiment, the present invention relates to a method of suppressing or completely eliminating hurricane/typhoon structures via the destabilizing effects of supersonic booms generated from one or more supersonic-capable aircraft (e.g., jet fighters). Jet fighters flying at supersonic speeds along special trajectories with a hurricane/typhoon at various altitudes would create supersonic booms. In one such embodiment, the trajectories for the supersonic booms of the present invention are counter to the rotational component of the hurricane and/or typhoon being targeted. As such, high level local velocity disturbances produced by supersonic booms can be tailored and/or designed to partially and/or fully negate the basic rotational contribution in a hurricane by slowing down a hurricane's/typhoon's rotation. Additionally, when supersonic booms propagate downward to the surface of the ocean they also destabilize a hurricane's/typhoon's structure by increasing the pressure in the central part of a hurricane's/typhoon's eye. In another embodiment, jet fighters flying just above the water can produce supersonic booms that will cause local ocean upwelling in various regions near and/or within the eye wall (EW) of a hurricane. This can result in “cutting off” and/or reducing the amount of warm water, and therefore warm air, available to fuel the hurricane.

As is noted above, the present invention, in one embodiment, relates to a method of suppressing and/or completely eliminating a hurricane/typhoon by generating one or more supersonic booms from any suitable source (e.g., a suitable aircraft such as one or more jet fighters). The jet fighters flying at supersonic speeds along a specifically designed trajectory or trajectories at one or more altitudes develop ultrasonic booms, which can be circumferentially directed in an anti-cyclonic rotation (e.g., a clockwise direction in the northern hemisphere or a counter-clockwise direction in the southern hemisphere), thereby reducing, mitigating and/or eliminating the major rotational aspect/contribution in the functioning of a hurricane/typhoon by the accumulation of local destabilization effects. When such supersonic booms propagate downward, they also will destabilize a hurricane's/typhoon's structure by increasing the air pressure in the central part or parts of a hurricane's/typhoon's eye.

Sonic booms (see, e.g., G. T. Haglund and E. J. Kane, Analysis of Sonic Boom Measurements near Shock Wave Extremities for Flight Near Mach 1.0 and for Airplane Acceleration, Report No. NASA CR-2417 (1970); and United States Air Force Fact Sheet, Sonic Boom) have been thoroughly investigated starting in the early 1970's in order to determine the possibility of damage from low supersonic travel. A sonic boom is an air shock wave (see, e.g., E. R. C. Mills, Supersonic Aerodynamics, McGraw Hill, New York (1950)) which follows an aircraft traveling at supersonic speeds and/or are generated due to an aircraft breaking the speed of sound (Mach 1). Such booms propagate downward with a conical wake. The technical characteristics of the sonic booms for the aircrafts flying with a speed close to, at, or slightly above the speed of sound (approximately 1225 km/hr or 761 mph at sea level) are as follows (see, e.g., United States Air Force Fact Sheet, Sonic Boom). The aircraft speed is commonly characterized by a Mach (M) number which is the ratio of actual aircraft speed to the speed of air sound at rest. Thus, an aircraft needs to achieve at some point a value of M of greater than 1 in order to generate a supersonic boom. The ground width of a boom exposure is about 1 km for each 200 m of altitude. So, a supersonic jet flying at an altitude of 10 km creates a lateral boom spreading out about 50 km at ground level. The duration of the shock wave in the boom at the resting spot on the ground is about 0.1 to about 05 seconds, with the velocity at the shock being close to its propagation speed and pressure varying with aircraft speed and decreasing with altitude. The strongest sonic boom ever recorded was produced by an F-4 jet fighter flying just above the speed of sound at an altitude 30 meters. This sonic boom was measured at a 144 pounds per square feet, and did not result in any injuries to the researchers exposed to boom (see, e.g., United States Air Force Fact Sheet, Sonic Boom). Nevertheless, sonic booms could/can cause damage to buildings if the pressure generated by such booms is more than about 16 pounds per square feet. Therefore the supersonic operations of jets are typically restricted to altitudes of more than 10 km. Additionally, it should be noted that the destabilizing value of sonic boom increases proportionally to the square of speed of aircraft.

As is noted above, the present invention, in one embodiment, relates to a method of suppressing and/or completely eliminating a hurricane/typhoon via destabilizing effects generated by one or more supersonic booms from any suitable source (e.g., a suitable aircraft such as one or more jet fighters). For example, jet fighters flying at supersonic speed along a one or more specifically designed trajectories in a hurricane/typhoon at one or more altitudes generate ultrasonic booms, which can be/are circumferentially directed in an anti-cyclonic rotational direction (e.g., clockwise in the northern hemisphere). This creates high level local disturbances that can eliminate, reduce and/pr mitigate a major rotational aspect of a hurricane/typhoon, thereby disrupting and/or elimination the functioning of such a weather feature. When the booms propagate downward they also will further destabilize the hurricane's/typhoon's structure by increasing the air pressure in one or more portions of the hurricane/typhoon eye.

Given their nature, supersonic booms are potentially very efficient in hurricane/typhoon suppression, mitigation and/or elimination. This is because, while not wishing to be bound to any one theory, supersonic booms destabilize and/or destroy the two major dynamic features of a hurricane/typhoon—steady maximum rotational speed in the eye wall area and the pressure deficiency located at/near a hurricane's/typhoon's vertical axis of revolution. For example, two F-4 jet fighters flying at approximately Mach 1.5 are sufficient, in one embodiment, to suppress, mitigate and/or destroy a typical sized hurricane/typhoon. Of course, larger or smaller hurricanes/typhoons may necessitate the need for more of less supersonic capable aircraft.

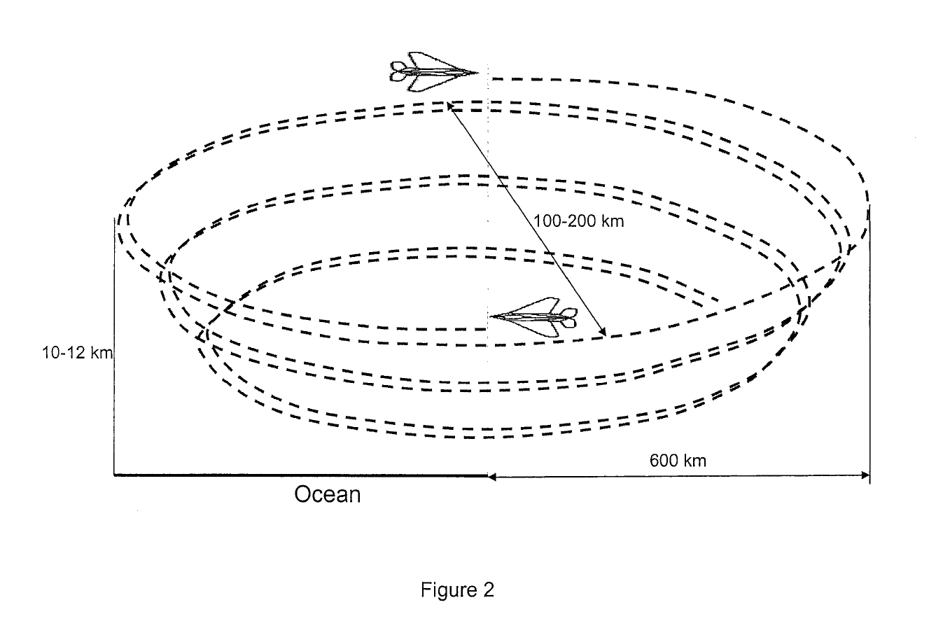

In the above exemplary embodiment, the destabilizing effects which suppress the cyclonic rotation in a hurricane/typhoon are achieved by synchronically flying a pair of jet fighters from the top of a hurricane down towards the ocean's surface in a anti-cyclonic direction (e.g., clockwise) in a flight pattern as is shown in FIG. 2 (that is somewhat circular or elliptical as it relates to a hurricane's/typhoon's geometry). To maximize the effect of the two fighter jets, the jets' trajectories should be symmetrically disposed relative to the center of the hurricane's/typhoon's rotation (see FIG. 2). In order to affect, by sonic booms, the rotating clouds beneath the highest flight points, the flights of the jets should start at about 12 to about 15 km in altitude. It should be noted that the present invention is not limited to any one set of parameters given that each hurricane/typhoon is unique in size, shape, height, etc.

In order to affect a larger region of rotating mass at each level, the longest distance of the elliptic plane orbit, in the horizontal place, is from about 300 to 400 km, or even up to 600 km. The shorter width of the elliptical flight trajectories is about 100 km (see FIG. 2). Additionally, in order to create the maximum impact of booms contra-rotation, the shortest distance between the two contra-rotating jets should be approximately equal to or less than the diameter of the hurricane maximum rotational wind speed (e.g., about 100 km). The identical trajectories of the two aircrafts with minimum three-four spirals down will eventually destroy a hurricane's functioning. Additionally, when the aircraft are close enough to the ocean surface, the supersonic boom will generate intense oceanic waves, thereby causing increased mixing of the water beneath such booms, which in turn can lead to a decrease in the surface air temperature at such locations.

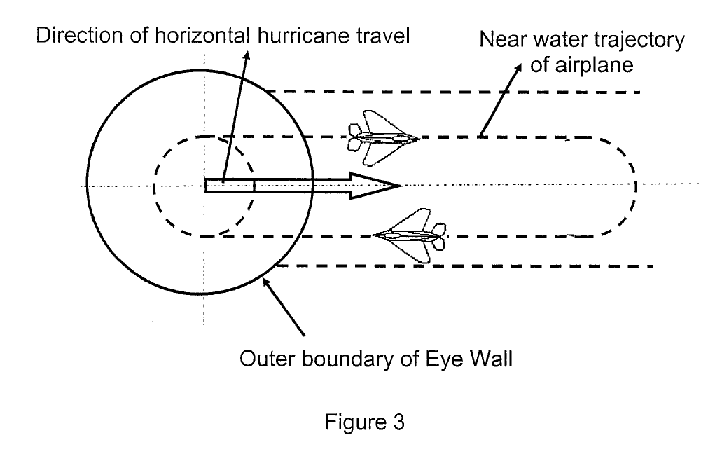

Additionally, a method in accordance with the present invention also can result in one or more indirect cooling effects. That is, sonic booms that are produced by jet fighters flying low above the ocean surface in both the eye wall (EW) area of a hurricane and a “feeding” area for the hurricane, will cause upwelling of cooler oceanic water. This will, among other things, result in an overall cooling of the air mass and/or water mass in such areas thereby resulting in a decrease and/or termination of the heat supply/fuel to a hurricane. Such a decrease would result in, at a minimum, a decrease in hurricane intensity. In another potential scenario within the scope of the present invention the sonic booms and the resulting decrease in available latent heat could result in termination of a hurricane. One possible set of trajectories for aircrafts flying close to the ocean are shown in a top-down view in FIG. 3. In one embodiment, such “low level” flights are conducted at an altitude of less than about 30 km, less than about 20 km, less than about 15 km, less than about 10 km, less than about 5 km, less than about 3 km, less than about 1 km, or even less than about 0.5 km. Again, it should be noted that the present invention is not limited to any one set of parameters given that each hurricane/typhoon is unique in size, shape, height, etc.

It should be noted that the trajectories of FIG. 3 are based upon a northern hemisphere hurricane/typhoon rotation. As can be seen from FIG. 3, the trajectories include the same trajectory in the eye wall (EW) region with anti-cyclonic rotation, while additionally including flights over the warm air and/or water streak “in front” of the hurricane's direction of travel. In the case of such low level flights, the flight path outside of the eye wall area are in substantially straight back and forth directions with regard to the hurricane's direction of travel.

It should be mentioned that the present invention is very fluid in nature since the pilots could easily change the trajectories and jet speeds. It means that after several trial attempts, better optimal trajectories of the jet fighters could be found, and it might be that the only one intensely flying jet fighter could be enough to destroy a hurricane.

There are plenty of sites along typical hurricane paths that are in the international waters where the jet supersonic booms could be generated in order to confirm that such booms destroy hurricanes. For the safety reason these areas should be located far away from shore, and not necessarily be to close to the tropical areas where hurricanes emerge/form.

Finally, flying in a hurricane at supersonic speeds (or near-supersonic speeds) is not harmful to the jets or pilots. In fact, flying in hurricanes at supersonic speeds is much safer than flying at low subsonic speeds. To date, a large number of hurricane renaissance flights at subsonic speeds have been performed in the name of hurricane research, with no report of any pilot injury.

The following articles are hereby incorporated by reference herein in their entireties:
(1) K. Emmanuel, Divine Winds, Oxford University Press, Oxford, New York (2005);
(2) G. T. Haglund and E. J. Kane, Analysis of Sonic Boom Measurements near Shock Wave Extremities for Flight Near Mach 1.0 and for Airplane Acceleration, Report No. NASA CR-2417 (1970);
(3) United States Air Force Fact Sheet, Sonic Boom; and
(4) E. R. C. Mills, Supersonic Aerodynamics, McGraw Hill, New York (1950).

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

What is claimed is:

1. A method of suppressing, mitigating and/or destroying a hurricane/typhoon due to the destabilizing effect of one or more sonic booms.

2. The method of claim 1, wherein the sonic booms are generated by one or more aircraft capable of supersonic flight speeds.

3. The method of claim 2, wherein the one or more aircraft while generating one or more sonic booms travel in essentially elliptical flight patterns in a direction that is opposite to the rotation direction of the hurricane's/typhoon's direction of rotation.

4. The method of claim 3, wherein the sonic booms are generated in an area in and/or around a hurricane's/typhoon's eye wall.

5. The method of claim 3, wherein additional sonic booms are generated at low altitudes along the hurricane's/typhoon's direction of travel.

6. The method of claim 1, wherein the sonic booms are generated at low altitudes along the hurricane's/typhoon's direction of travel.

7. The method of claim 2, wherein one or more sonic booms are produced at an altitude of less than about 30 km.

8. The method of claim 2, wherein one or more sonic booms are produced at an altitude of less than about 20 km.

9. The method of claim 2, wherein one or more sonic booms are produced at an altitude of less than about 15 km.

10. The method of claim 2, wherein one or more sonic booms are produced at an altitude of less than about 10 km.

11. The method of claim 2, wherein one or more sonic booms are produced at an altitude of less than about 5 km.

12. The method of claim 2, wherein one or more sonic booms are produced at an altitude of less than about 3 m.

13. The method of claim 2, wherein one or more sonic booms are produced at an altitude of less than about 1 km.

14. The method of claim 2, wherein one or more sonic booms are produced at an altitude of less than about 0.5 km
